(19) United States
(12) Patent Application Publication
(10) Pub. No.: US 2010/0321527 A1
(43) Pub. Date: Dec. 23, 2010

(54) METHOD AND APPARATUS FOR CAPTURING AND DISPLAYING IMAGES

(76) Inventor: Mark van Schalkwyk, Brooklyn, NY (US)

Correspondence Address: GOTTLIEB RACKMAN & REISMAN PC, 270 MADISON AVENUE, 8TH FLOOR, NEW YORK, NY, 10016-0601, US

(21) Appl. No.: 12/789,844

(22) Filed: May 28, 2010

Related U.S. Application Data
(63) Continuation-in-part of application No. 11/537,229, filed on Sep. 29, 2006, now Pat. No. 7,728,885.

(51) Int. Cl. H04N 5/76

(52) U.S. Cl. 348/231.2; 348/E07.001

(57) ABSTRACT

An apparatus for capturing and present images includes one or more master controllers with an image capture device capturing many images. The images are ordered in defined sequence and presented in a large venue on a plurality of screens using respective remote slide show controllers.

### RELATED APPLICATIONS

This application is a continuation-in-part of application Ser. No. 11/537,229 filed Sep. 29, 2006, incorporated herein by reference, now U.S. Pat. No. 7,728,885

### BACKGROUND OF THE INVENTION

a. Field of Invention

This invention pertains to a system and apparatus for capturing high quality digital images of models and other subjects and to display the images concurrently on a plurality of large screens. Optionally, the images are stored and/or printed.

b. Description of the Prior Art

Photo booths have been with us since the 50's and they are used to make wallet sized pictures using wet chemistry. The pictures produced are very low quality but the devices are somewhat popular because they provide almost instantaneous results.

More recent apparatus have been proposed that produce somewhat better results. See for instance U.S. Pat. No. 5,262,815 disclosing a modular photographic system, U.S. Patent Publication 20010011262 disclosing a digital public photo booth capable of sending a digital image to a remote location; Japanese Patent Publication JP 2001311993A2 which discloses a photo booth that takes a picture of a subject and superimposes a selected background on the resulting image; U.S. Pat. No. 5,623,581 discloses takes an image of a subject, defocuses the background and superimposes a selected image as background; U.S. Pat. No. 6,298,197 discloses a photo booth generating pictures by printing images from a video camera; EP Application 1059799 discloses a digital photo booth with a video camera generating images of a subject, a monitor for displaying the images and a printer for making pictures from the images; U.S. Pat. No. 3,852,783 discloses an electronic photo studio with strobe lights a camera exposing images on a film and a processing device for developing the exposed film; U.S. Pat. No. 5,446,515 discloses a photo booth with a movable camera and a movable background.

However, all these devices are constructed and designed as a unitary permanent or semi-permanent structure placed usually in a high volume area. Moreover, the quality of images and pictures obtained from these devices are not very high.

### SUMMARY OF THE INVENTION

The present invention allows users to capture images of themselves, which are then stored on a computer hard drive and displayed via large displays such as plasma screens, projection screens, video screens and the like, as well as on a computer monitor. The images of subjects may also be captured by an attendant. Once several images are collected, they can be displayed sequentially, initially in the order in which they are captured as a slide show presentation. One important feature of the invention is that lighting elements are used to light the subjects in extremely flattering manner. Another important feature is that once a group of images are captured, the sequence iof images is repeated automatically. However, while the sequence is repeated, when a new image is captured, a master controller instantly inserts the current or new captured image and inserts into the sequence so that it is the next image to be presented, ahead of some of the images that have been captured previously. This creates an interaction between the user and the equipment that has not been available before.

Preferably the system for performing the invention includes an image capture apparatus disposed in a self-contained case and the created images are stored in an electronic folder. A slide presentation program checks the contents of the folder and presents the images through a distribution network to a plurality of screens.

### BRIEF DESCRIPTION OF THE DRAWINGS

FIG. 1 shows a block diagram of an image distribution system constricted in accordance with this invention;

FIGS. 2A, 2B and 2C show a front, side and back view of an image acquisition apparatus used in the system of FIG. 1;

FIG. 3 shows a block diagram of the image acquisition apparatus of FIGS. 1A-2C;

FIG. 4 shows a flow chart showing how newly acquired images are displayed;

FIGS. 5-9 show block diagrams of various alternative embodiments of the invention;

FIG. 10 shows a flow chart for generating and manipulating a text file by the folder watcher to keep track of the pictures being captured and then presented;

FIG. 11 shows a flow chart for setting up a system in accordance with this invention.

### DETAILED DESCRIPTION OF THE INVENTION

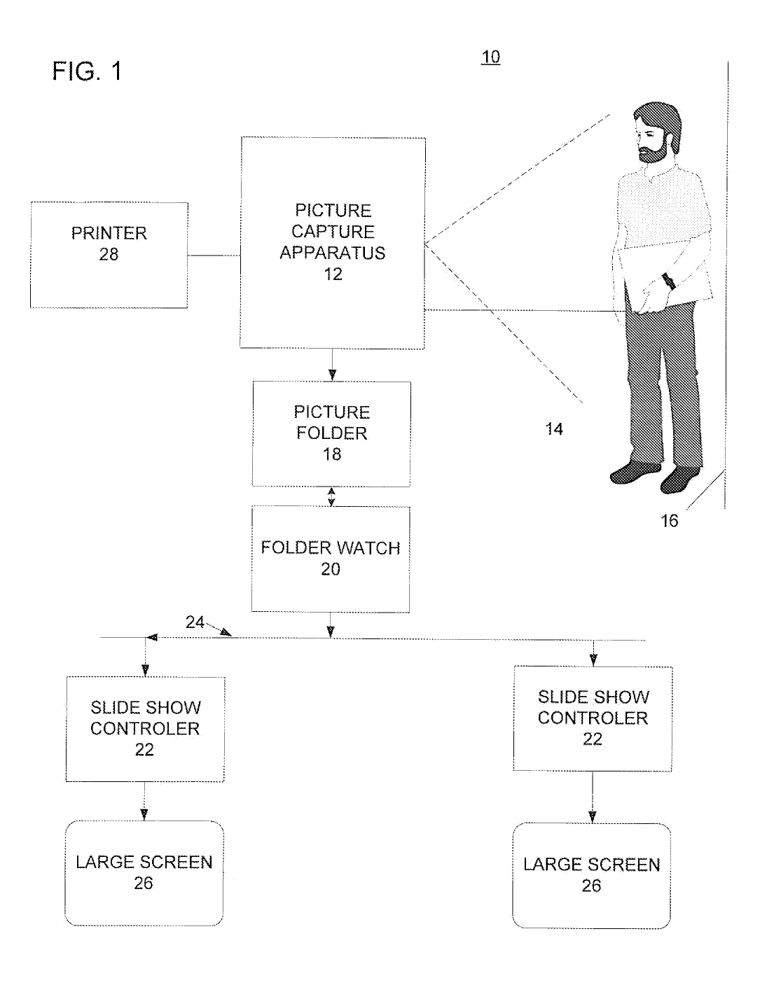

Referring now to FIG. 1, a system 10 constructed in accordance with this invention includes a picture capture apparatus 12 used to capture an image of a subject 14. Preferably, a screen 16, a wall or other opaque means are used to block extraneous objects so that they do not appear in the image. Moreover, the screen 16 may also be used to provide a static or dynamic background for the image.

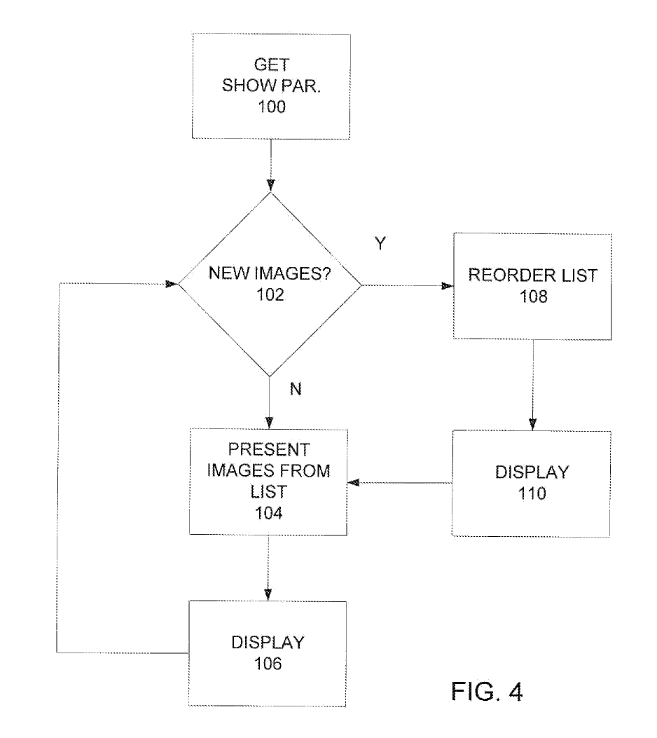

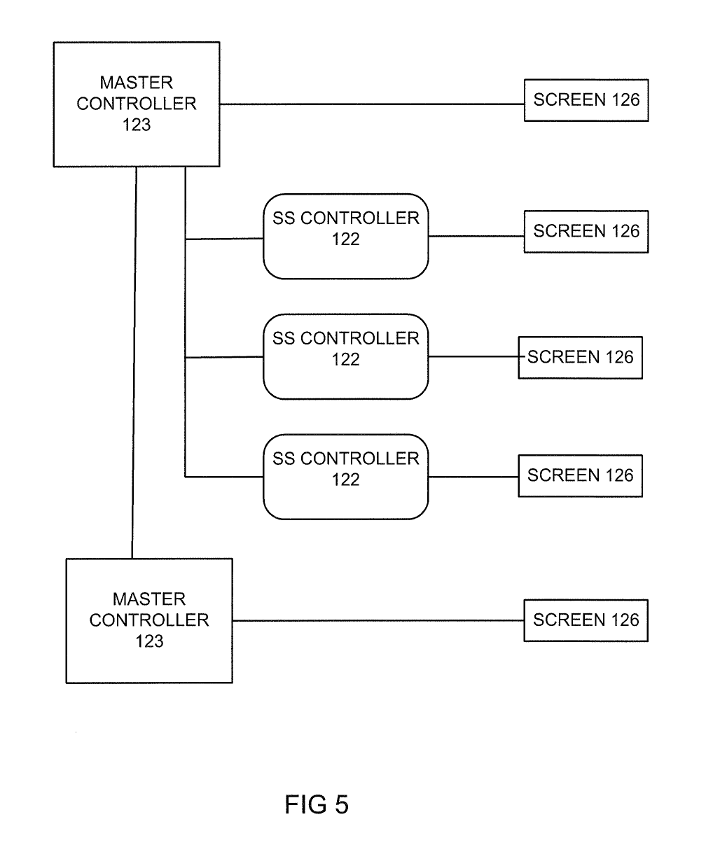

The images from the apparatus 12 are stored in a picture folder 18. Folder 18 may be an electronic file stored on a hard-drive, or any other memory means such as flash cards. The contents of the folder 18 are monitored by a folder watch 20. The images are then distributed to a plurality of microprocessor-based slide show controllers 22 via network 24. The controllers 22 feed the images to respective large screens 26. The screens 26 may have different sizes, types and formats and therefore may require different the images in different formats as well. The controllers 22 receive the images from folder watch 20 in a standard format and then convert them into any respective formats, as needed, and present them for a predetermined time period, such as three seconds. Details of how this can be implemented are discussed below, in conjunction with the flow chart of FIG. 4. The network 24 can be a wired or a wireless network and images can be presented by remote controllers either when they or on off line.

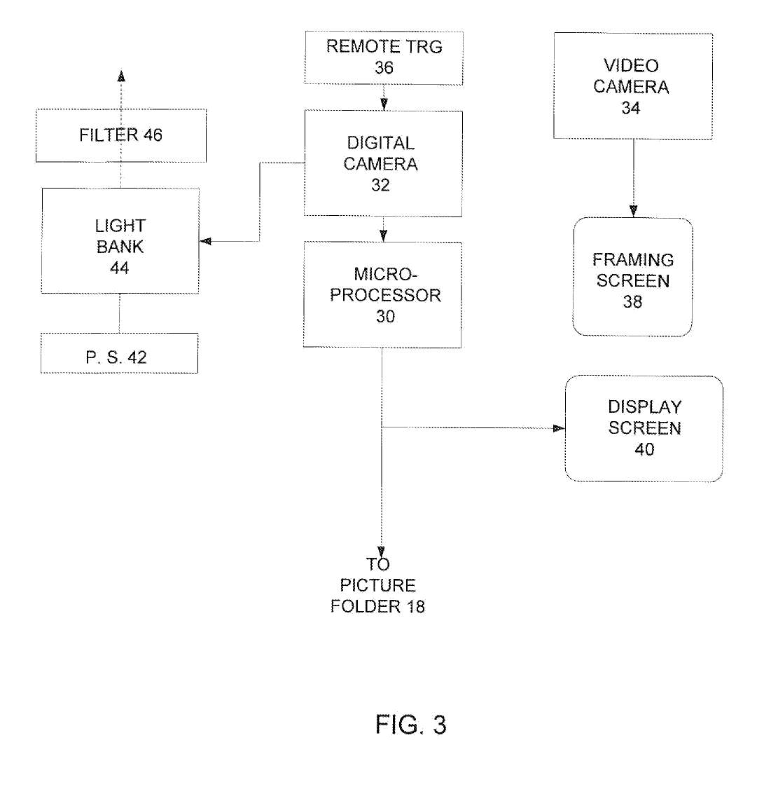

Preferably, the current folder 18 and the folder watch element 22 are implemented as software running on a microprocessor incorporated in the picture capture apparatus 12, as shown in FIG. 3, however they are shown here as separate elements for the sake of clarity.

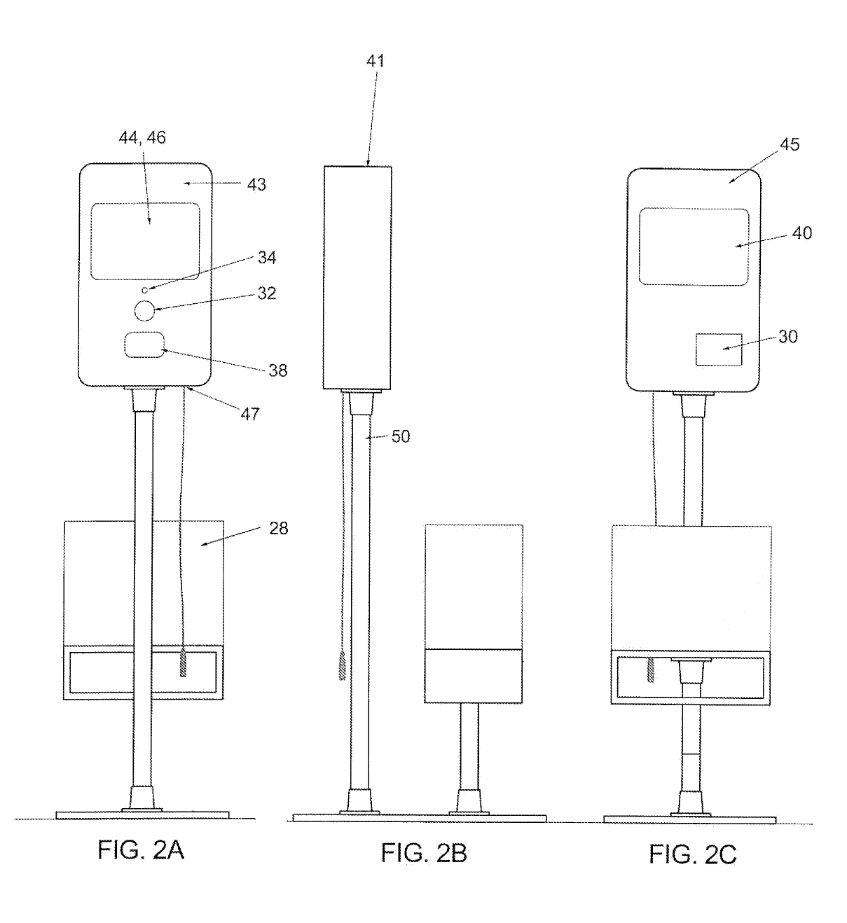

Referring now to FIGS. 2A-2C and FIG. 3, the image capture apparatus 12 includes a microprocessor 30, a digital camera 32, a video camera 34, a remote trigger, a framing screen 38 and a display screen 40. Screen 40 can be a standard screen or a touch screen so that an operator can enter commands to the microprocessor. Some additional elements are a power supply 42 that provides power to a light bank 44. The light bank generates a burst of light which is dispersed through a a ⅛″ Plexiglas diffuser 46.

These elements preferably are installed in a common case 41 having a front wall 43 and a rear wall 45, as shown in FIGS. 2A-2C. The front wall is formed with apertures for the diffuser 46 covering the light bank 44, the video camera 34 and the digital camera 38. A socket 47 is also provided for connecting the trigger 36 to the system. Alternatively the trigger 36 may be an RF or infrared (IR) device in which case the socket 47 is replaced by an RF or IR receiver. A power supply (not shown) is included in the case to provide power to the various described elements.

The back wall is formed with an aperture for a display screen 40. The display is used to provide instructions to a user, to display advertising and other information or to display the same images as screens 26. The case 41 can be attached or mounted on a support 50. The case 41 is attached with two quickly released bolts and wing nuts (not shown). The bolts are pushed up into the case for transport and drop down when the case is set on the stand. A great advantage of the system is that the case 41 is easily removed from the support 50 and carried easily from one location to another, or stored. The case may be 32″ high, 18″ wide and 8″ deep. Alternatively, with smaller and lighter components, the size of the housing can be reduced to 23″ high, 16″ wide, 6″ deep and weight of no more than 27 pounds.

The following parts may be used to implement the image capture apparatus, the picture folder and the folder watch it being understood that a person skilled in the art could easily replace any of these elements with other equivalent devices. These elements form and are referred to below as a master controller.

Microcomputer 30 Apple—17″ iMac 1.9 GHz G5 with 2 g Intel processor) or HP Touchsmart Laptop

SP-Systems Sync Cord—Male Phono to Male PC, Straight—10′

Light bank 44—Paterson Cyber Flash Panel—rated at 300 Watt/Seconds and preferably set to 75% output.

Trigger 36—Canon Remote Switch RS-80N3 for Canon EOS Cameras
1 Canon ET-1000N3 Cord for All N3 (EOS 3 & 1V) Accessories—33′ 1 Canon ACK-E2 AC Adapter Kit for EOS 20D & EOS

Digital camera 32—Canon EOS 20D, 8.2 Megapixel, SLR, Digital Camera with Canon 18-55 mm Lens, or a Canon Digital Rebel.

Video Camera 34—Varizoom VZ-TFT 5.6-Inch Camera

Framing screen 38—5″ LCD monitor

Display screen 40—15″ LCD monitor if a MAC is used instead of a Mac mini no additional monitor is required as it is incorporated into the Imac.

Optionally, this master controller can also be used to present images on a large screen in a manner similar to the slide show controllers 22.

The image capture apparatus 12 operates as follows. A subject 14 steps in front of the case 41 with his back to screen 16. He holds in his hand the remote trigger 36. When he is in front of the apparatus 12, the video camera 34 captures his image and shows it on the framing screen 38. For this purpose, the screen 38 is shown connected directly to the video camera, although the output of the video camera could be fed to the microprocessor 30 as well for framing purposes or other functions. Once the subject 14 decides that he is in the desired position and likes the image on framing screen 38, he is ready to take his picture. Preferably, cameras 32, 34 and framing screen 38 are aligned and disposed close to each other to eliminate or reduce parallax problems.

The subject 14 takes his own picture by activating trigger 36. This causes the digital camera 32 to activate the light bank 44 thereby causing a flash to be directed from the light bank 44 at the subject 14. As discussed before the light bank is selected to provide sufficient light for a pleasing, natural flash. The camera 32 then records the image in its memory (not shown) and passes the image to the microprocessor 30. The microprocessor 30 then stores the image as a digital file in a *jpg or other similar formats in the current picture folder. The image is then displayed on one or more large screens as described below. Optionally, the apparatus 12 is connected to a printer 60 to print out pictures from the digital images. The printer can be at any point in the network. It does not need to be at or connected to the apparatus. These functions can be implemented using off-the-shelf software such as Canon Digital Photo Professional and Canon Remote Capture.

The display of images is now described in conjunction with the flow chart of FIG. 4. This flow chart shows one possible mode of operation for the system 10. Initially, a sequence of images P1, P2, P3, . . . P100 are captured and stored in the picture folder 18. In step 100 the folder watch 20 obtains or receives commands or rules related to the manner in which the pictures are to be displayed. Preferably, the pictures are displayed sequentially, in the order in which they were taken, as soon as they are taken (optionally, the picture may also be presented randomly, in alphabetical order, etc.). Let's assume that after the first 100 pictures are taken, nothing happens for a while. During this time, in step 104, after picture P100, the microcomputer goes back to the beginning of the list and starts showing pictures P1, P2, P3, P4 . . . again. In step 102 the folder watch 20 keeps looking for new images in the folder 18 and as long as no new pictures are found, the pictures are shown in the original sequence. (Of course, this step may be implemented at other stages of the process as well).

At a later time T, a new image is captured and stored as a current image C1 in folder 18 while picture P37 is presented. If in step 102 in the event that there is new image is sensed and in step 108 the newly loaded image C1 from the image capture apparatus is obtained from the folder and immediately displayed in step 110. Thereafter, the new images are placed in the designated sequence. If a second new picture C2 is captured and stored, this picture C2 is shown immediately after C1 (assuming that it is processed fast enough). Otherwise the slide show resumes in step 104 with the next image on the list e.g., P38. Of course the system can be modified easily to show the images in many different orders. Moreover the order in which the images are shown, need not be the same for all the screens 26, and not all the images need to be displayed on all the screens as discussed in more detail below.

To summarize, in the system shown in FIGS. 1-4, pictures are captured in real time by apparatus 12 and stored in a picture folder 18. The picture folder 18 is monitored by a folder watch 20. Once one or more pictures are captured and stored in this manner, they are retrieved, sent to the remote slide show controllers 22 which then displays them in sequence on large screens 22. In one embodiment, all the pictures appear in the same sequence on all the screens 22, however, since each of the slide show controllers can operate independently, because of various delays inherent in the system, the time needed to execute each loop to display each picture and other effects, normally, the pictures do not appear on all the screens simultaneously. However, whenever a new picture is received from the apparatus 12, the sequence is changed by inserting the new picture into the sequence. In other words, the sequence is changed by interleaving each new picture (or each new sets of pictures) between existing pictures so that the new pictures are shown in the new sequence ahead of some of the older pictures. In this manner, the list of pictures keeps on growing during the event. If necessary, once a limit is reached, older pictures may be deleted from the list.

In an alternate embodiment, the slide show controllers are adjusted so they all present the same picture simultaneously. The easiest way to synchronize the pictures on different screens is by adjusting the operation of the slide show controllers to accept a sync signal, for example, from the master, which then causes the picture in the sequence to be presented. Alternatively, a sync signal may be derived from other sources or in response to some predetermined events.

In an alternate embodiment, the folder watch and/or slide show controllers are adjusted by an operator so that not all the screens show all the images. For example, some screens may show all the odd numbered pictures while others may show all the even. Alternatively, one set of pictures may be shown on some screen and a different set of pictures can be shown on different screens.

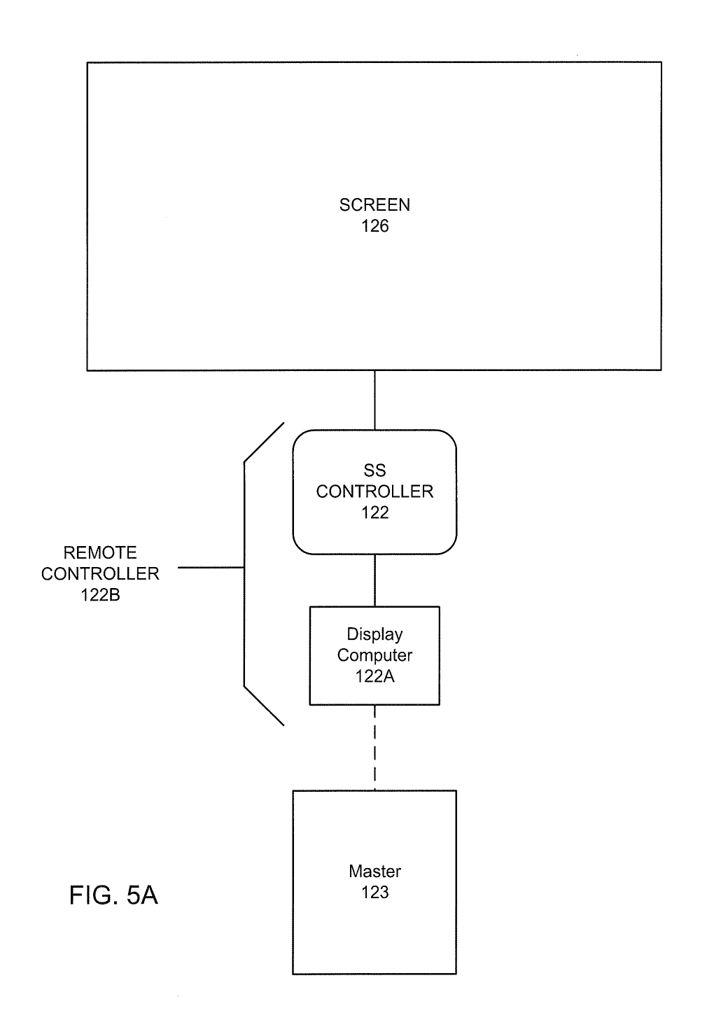

In yet another embodiment, shown in FIG. 5 several different master controllers 123 are provided, each master having a picture capture apparatus, a picture folder and a picture folder watch, as illustrated in FIG. 1. Each master controller 123 provides pictures to its own set of slide show controllers 122 which then presents these pictures on screens 126. For example, at a wedding, one master controller would take pictures of the groom's family, while the other master could take pictures of the bride's family. The different master controllers 123 can supply to or exchange pictures from each other as well, for example, when requested by an operator, at set time interval, etc. In other words, in the embodiment of FIG. 5, the two master controllers 123 are used to capture different sets of images. The sets are presented on displays 126. In one alternative, each master controller generates its own file of pictures and its own list. However, some or all of the pictures from one master controller can be shared with the other master (and its controllers 122). In another alternative, the two masters cooperate so that a single folder is used to store all the images and a single sequence is generated for the masters and their remote controllers. It should be understood that images are presented to each remote screen 126 of FIG. 5 as follows and shown in FIG. 5A. Images from master 123 are sent to a remote controller 122B consisting of a display computer 122A and a slide show controller 122 that is preferably implemented by software in the display controller 122A, however it is shown in FIG. 5A as a separate component for the sake of clarity. Similarly in some of the following embodiments, only the slide show controllers for the sake of clarity.

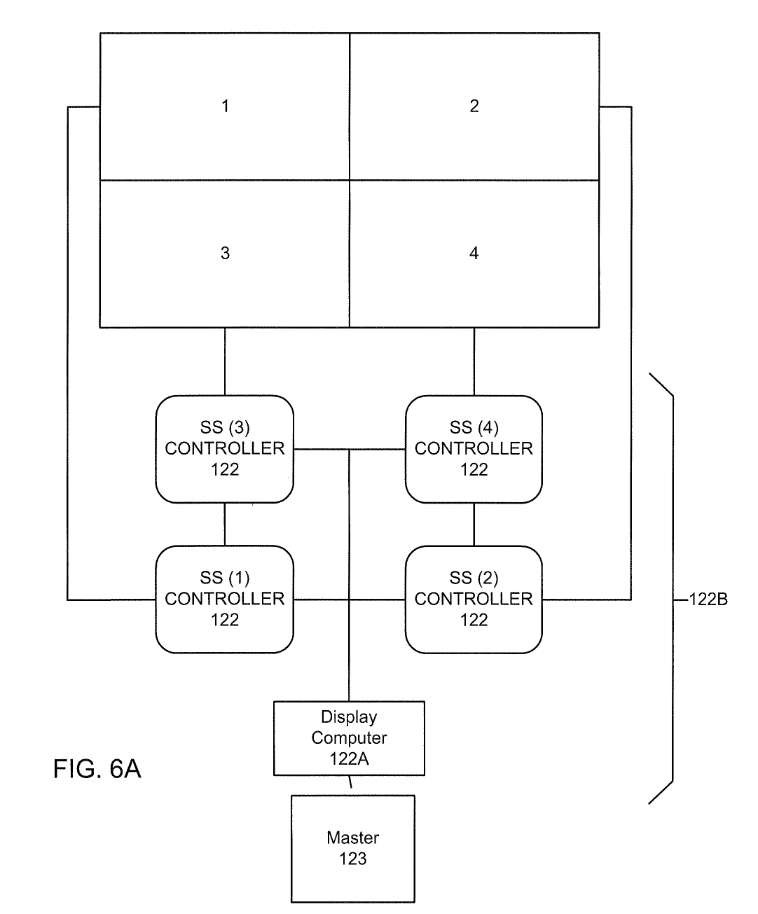

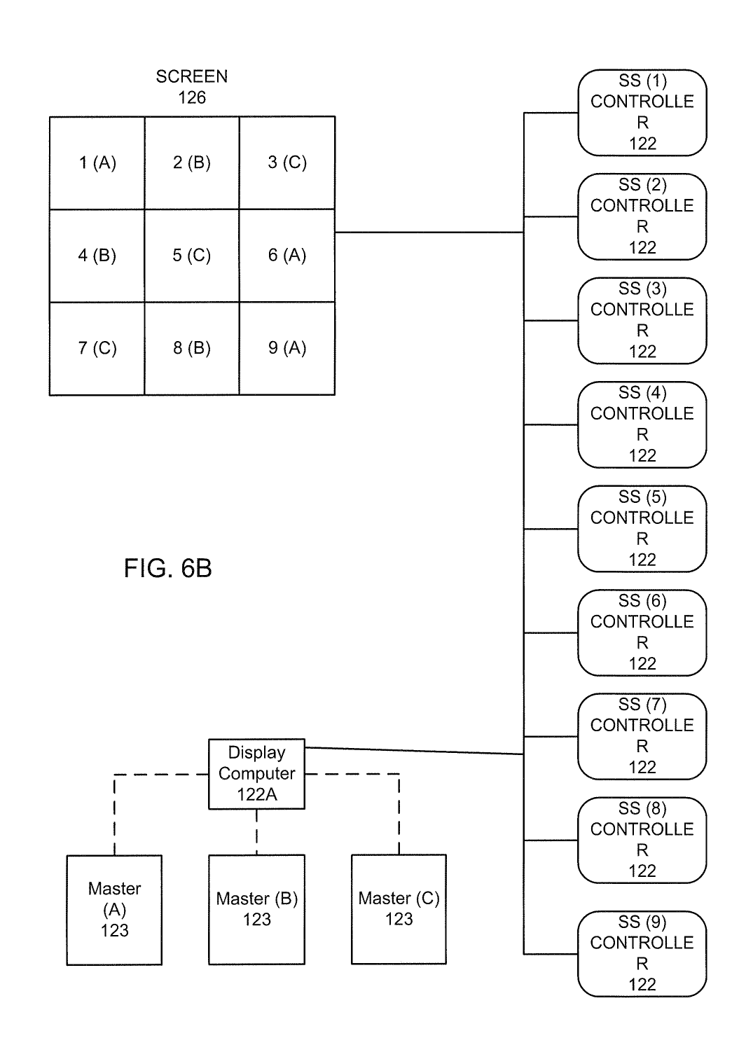

FIG. 6A shows yet another embodiment. In this embodiment, a plurality of a remote controller 122B has four slide show controllers 122A run by a display controller 122A that receives pictures from a master controller 123. A single large display 112 is provided, which is partitioned into a plurality or array of sections (e.g., 2×2). The display computer 122A controls what images are presented on each of the segments of display 126.

FIG. 6B shows yet another embodiment similar to the embodiment of FIG. 6A. In this embodiment, a plurality of a remote slide show controller 122 receives pictures from several master controllers 123. A single large display 112 is provided, which is partitioned into a plurality or array of sections (e.g., 3×3, 4×4, 2×4, etc.) A display computer 122A controls what images are presented on each of the segments. For example, in FIG. 6, segment 1 shows images from master A, segment 2 shows images from master B and so forth.

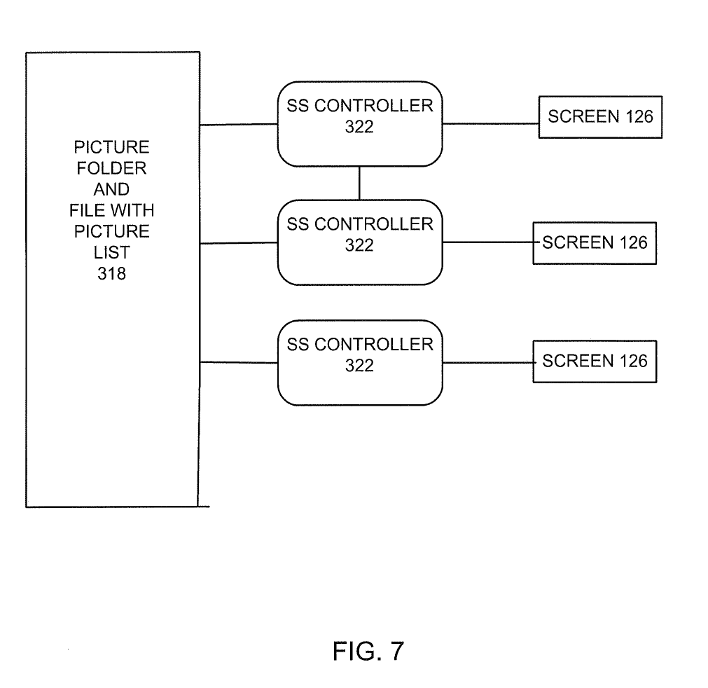

FIG. 7 shows an embodiment in which the controllers 322 receive pictures from a picture folder 318 in a partitioned sequence. Preferably the picture folder is part of the master controller, but could be somewhere else as well. The difference between this embodiment, and the previous embodiments, is that in the previous embodiments, pictures were retrieved from the picture folder and provided to the slide show controllers in the same predetermined sequence. In this embodiment, several pointers are provided that are pointing at different portions or segments of the sequence. For instance, one pointer could be used to identify and retrieve picture P1, the next pointer could identify picture P11, the next pointer would look at picture P21. As a result, each of the controllers 322 would show the same sequence of pictures but the sequence from one screen to the other would be offset by 10 pictures. (Of course any other integer may be used as well). In this manner, people could watch different portions of the sequence by looking at different screens 126. For example, a person sees himself on one screen 126 and would like to see himself again soon. Since the screens are delayed from each other, he may be able to see himself soon by watching a second screen.

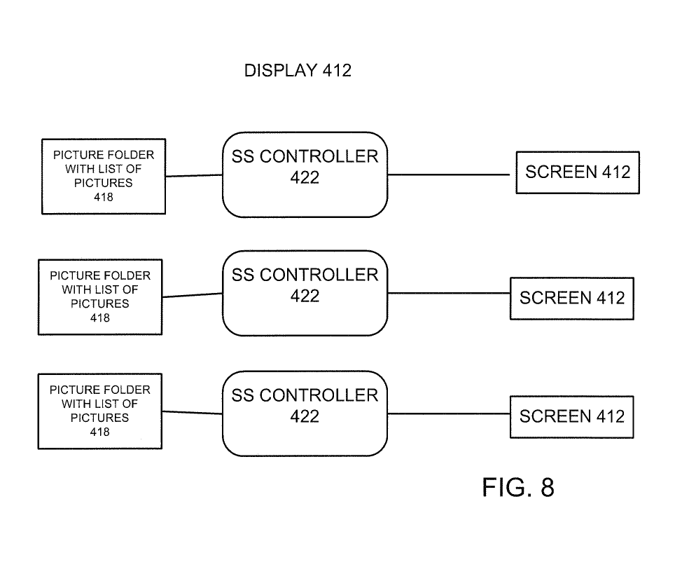

In another embodiment shown in FIG. 8, several picture folders 418, each with its own list of pictures may be provided from one master or more than a master, and presenting pictures to respective slide show controller 422. Each slide show controller then presents the pictures on respective screens 412.

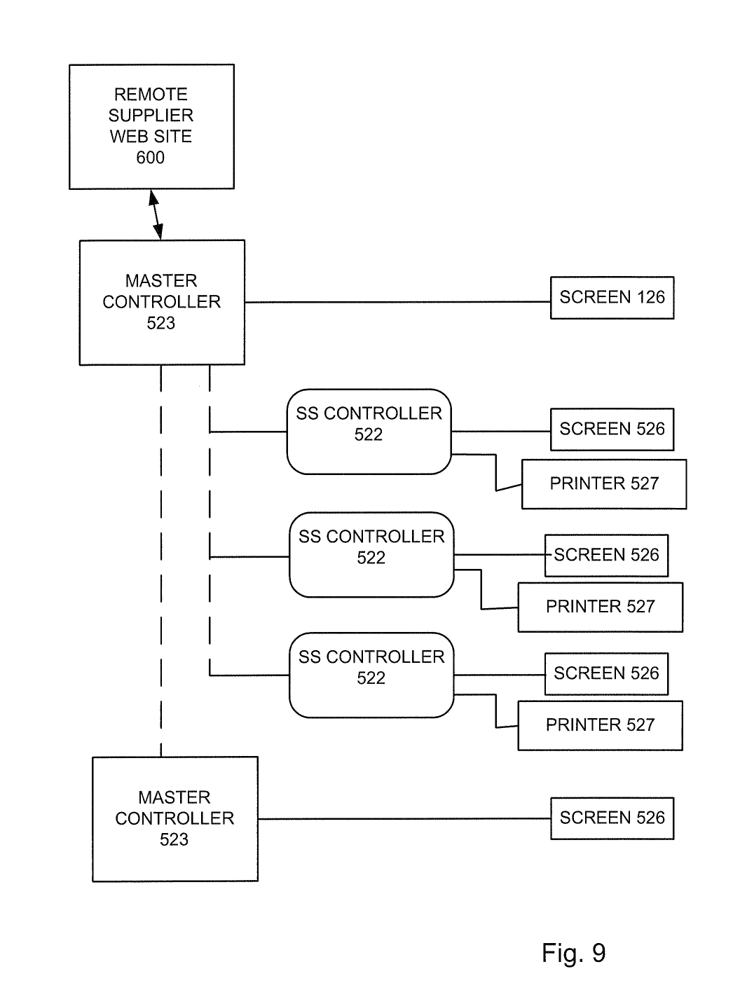

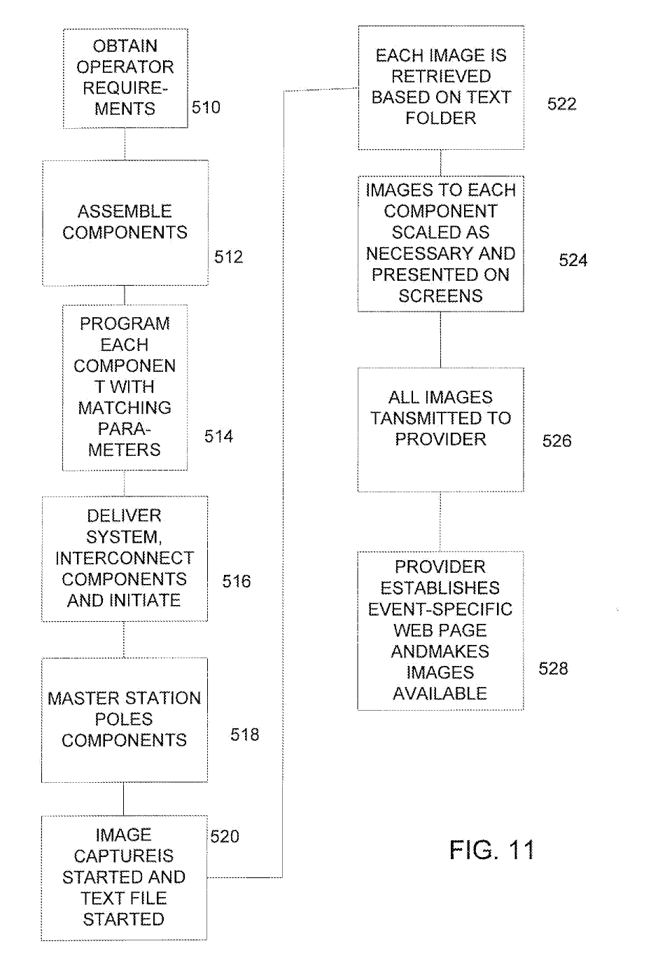

In the embodiments discussed so far, the master controller and the slide show controllers are all disposed in the same venue and are interconnected via a wired or wireless LAN. Depending on how the masters and the remote controllers are set up, the various elements can be operating either on or off line, as previously mentioned. In the embodiment of FIG. 9, the various elements, such as masters 523 and slide show controllers 522 are disposed at different locations and are interconnected via an Internet connection. The controllers 522 can present the pictures on screens 526 and/or print them on a printer 527 disposed remotely of the master controllers 523. Moreover, various information, including programming, logos, and other information can be interchanged with or a received from a remote supplier 600 that is preferably implemented on a website platform. Details of some of these operations are discussed below in conjunction with FIG. 11.

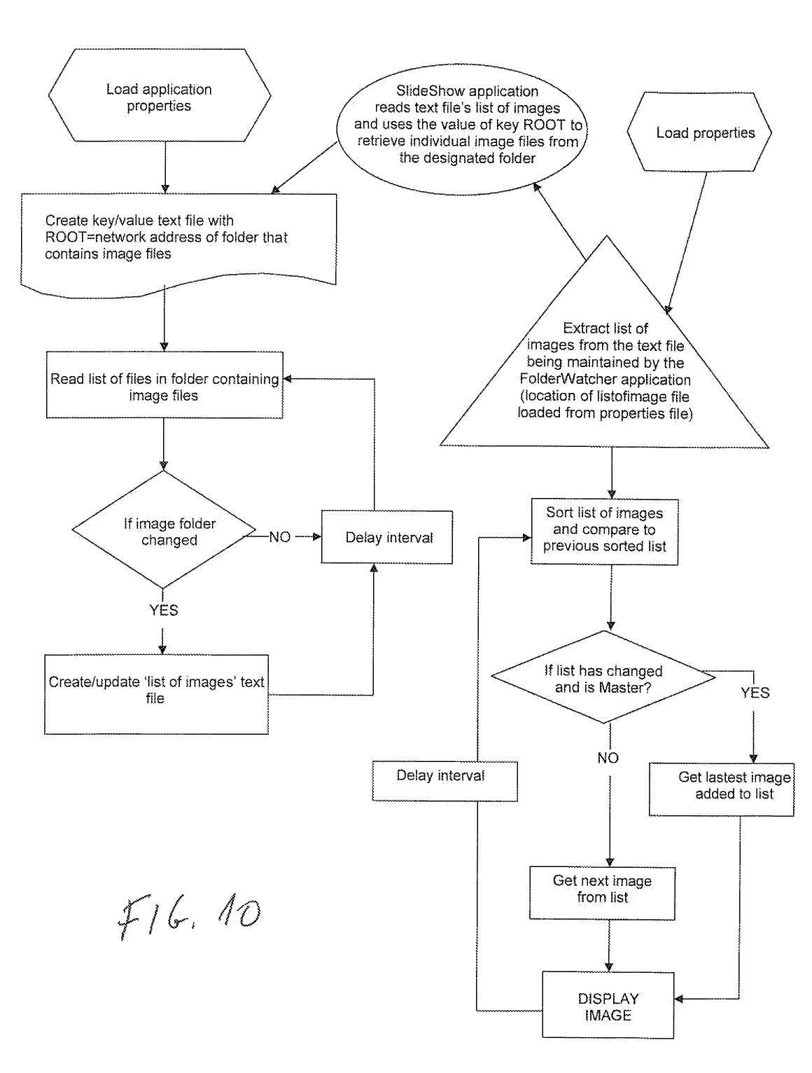

As can be seen from the above description the described system allows for various different types of image sequences to be show on each display device or screen. The system is adapted to insert the newest image into each of the screens as the next slide. Further, when multiple master controllers are provided, each image display area or screen can be set to view images from the different master controllers. Preferably, the folder watcher is a client application implemented at the master controllers and is configured to generate and manipulate the list of images as a text file. FIG. 10 shows a flow chart illustrating this aspect of the invention.

Preferably, the system is set up so that it is modular and flexible to use. It is presently envisioned that a supplier supplies the elements for different systems including the master controllers, slide show controllers, screens, etc., in conformance with the requirements for each operator. This process is illustrated in FIG. 11. First in step 510, supplier obtains the operator's requirements (e.g., number of masters, slide show controllers, screens, interconnection means, printers, paper, etc.).

Next, in step 512 the supplier assembles the components. In step 514 the operator programs each component for the desired process each component being configured with the required parameters and having an iD code In step 516 the supplier delivers the system, and the customer then sets ups the system at the desired venue and initiates the master controller. In step 518 the master controller poles all the components to make sure they are connected properly. Image capture starts in step 520 and proceeds as described. As part of its functions, the master controller stores the pictures, generates the text file designating the desired sequence. In step 522 each image is retrieved based on information from the text file. In step 524 the images are scaled for components if necessary (for example, a slide show controller servicing a 12″ monitor may not need a picture with the same resolution (or size) as a slide show controller for a 60″ LCD screen. The pictures are then presented in accordance with one of the embodiments described.

In step 526 the images are also transmitted back to the supplier. The supplier optionally sets up a web pages for the specific event and makes the images available on line to users, either on demand, or as otherwise required. The pictures can be presented as thumbnails on a website or as full blown pictures. A viewer can watch the images any time during, or after the event, and, optionally can order hard copies of the event either while the event is going on, or later.

Here is a typical scenario illustrating these principles more concretely.

Doug is a photographer in Phoenix and is customer of the supplier. He's going to run a few events. The supplier has shipped him the hardware consisting of a master controller, two slide show controllers, two screens and a printer.

One of the events is tomorrow night, so Doug has to set up master controller for this particular event. The client has a logo he wants to appear on the photos. They'll be displaying photos on two projectors, each at a different resolution. This event is going to have a web gallery, which will be visible from supplier's website, and the pictures are going to be loaded sometime after the event.

Doug logs onto the supplier's site the computer that is part of the master controller or any computer connected to the web. For this example, let's say he's on his laptop. From there, he creates a new event, plugs in the relevant information and uploads the client's logo.

He is taken to a link with a zip file to download. The next time he goes to the master controller, he opens the browser (which opens to the supplier's homepage) logs on and goes to the event he created. He can access the download from here, so he downloads it to the booth's hard drive.

From here, he unzips the file. Doug double clicks it and a setup program runs. Because the event is already configured, Doug doesn't have to do much. He just lets it run.

Now the master controller booth is configured, all Doug needs to do is double click on a file called Start Event.

When Doug set up the event on the supplier's site, he also prepared the event's online gallery.

At the end of the event, Doug double clicks a file called Upload and the images are uploaded to the web gallery.

When Doug creates the event, the backend of the web gallery is set up.

Folders are created, a scheduled task is started to watch for new images.

All the properties files for the software that runs on the master controller are generated. The newest versions of all the software are checked out of a repository and an install file is created. The upload script is configured with all the information it needs so the end user doesn't need to bother with FTP software and passwords. The upload script can be configured (at the time of event creation) to run alongside the process software so galleries can be uploaded in real-time. It continues to run until all the files are uploaded. If it loses its connection, it keeps trying until it gets a new one.

These files are zipped up and made available to the user.

If the user has made a mistake or needs to edit something, he or she simply edits the event in the admin tool, re-saves and downloads and installs the new version.

Numerous modifications may be made to the invention without departing from its scope as defined in the appended claims.

1. An apparatus for presenting images to viewers in a venue comprising:
an image capturing device capturing a current image;
a picture folder storing images captured by the image capturing device in a sequence; and
a controller presenting images from said sequence to a screen; and
wherein said controller is adapted to modify said sequence inserting said current image into said sequence, said current image being shown by said controller ahead of at least one older image in said sequence.

2. The apparatus of claim 1 further comprising a plurality of remote controllers, each controller being associated with a respective remote screen and each remote controller receiving images and presenting respective sequences on said remote screen.

3. The apparatus of claim 2 further comprising a master controller with said image capturing device, a local controller for ordering pictures in said sequence and said folder monitor.

4. A system for capturing and displaying images comprising:
an image capture apparatus including a case, a digital camera selectively activated to obtain digital images of subjects and disposed in said case including a current image;
a controller monitoring establishing a first list defining a sequence of initial images including a first image followed by a second image, said controller being configured to generate a new list defining a second sequence including said current image in said second sequence, wherein in said second sequence said current image is positioned between said first and second images; and
at least one display receiving images from said controller in one of said first and second images.

5. The system of claim 4 wherein said image capture apparatus includes a framing element to assist a subject in framing the image.

6. The system of claim 5 wherein said framing element includes a video camera showing a video image of a field and a framing display showing said field.

7. The system of claim 4 wherein said case is portable.

8. The system of claim 4 wherein said displays are adapted to receive said images through a network.

9. A system for creating slide shows in a venue comprising:
a photo booth including a digital camera, said booth being arranged and constructed to generate a current image of a user by using said camera;
an image folder coupled to said camera and receiving said current image; and
a display assembly disposed away from said photo booth and connected to said image folder, said display assembly including a display and a slide controller presenting a sequence of images on said display, wherein said slide controller interrupts said sequence and inserts said current image into said sequence and presents said sequence of images with said current image being presented immediately after said current image is received from said photo booth.

10. The system of claim 9 wherein said display assembly is connected to said photo booth by one of a wired and a wireless network.

11. The system of claim 9 wherein said photo booth includes a local screen with said camera being directed at said screen, whereby the user stands in front of the screen to have said image taken by said camera.

12. The system of claim 9 wherein the photo booth further includes a local display and an auxiliary camera for generating an instantaneous image of the user on said local display for framing.

13. The system of claim 9 wherein said photo booth further includes a trigger mechanism activated by the user to trigger the camera.

14. The system of claim 9 further comprising a plurality of display assemblies connected to said photo booth by a communication network, each display assemblies being disposed at a remote location from said photo booth and being arranged and constructed to show a slide show of initial images arranged in sequence independently of the other display assemblies and wherein each display assembly cooperates with said folder to show said current image on each display by inserting said current image immediately after said current image is generated.

15. A method of producing slide shows in a venue, comprising:
arranging a plurality of displays in said venue to display a respective slide show by presenting a sequence of images in order, each respective sequence including a respective first and second image;
providing a photo booth including a digital camera and accessories designed for taking a picture with the digital camera to generate a current image;
obtaining a current image of a user from said photo booth;
transmitting said current image to each of said displays;
at each display, inserting said current image into said respective sequence, wherein each display shows, in sequence, said first respective image while said current image is acquired, said current image and said second image; and checking at predetermined intervals if there is a current image available, and if there is no current image available, then playing said preselected images in said sequence.

16. The method of claim 15 further comprising sending said current image to said displays via a network.

17. The method of claim 15 further comprising storing a plurality of images in a folder associated with said photo booth and generating said slide shows using images from said camera.

18. The method of claim 17 further comprising editing images in said folder without interrupting the slide show at any display.

19. The method of claim 15 further comprising printing images automatically upon capture and display.

20. The method of claim 15, wherein said photo booth and said display are in a single room and said sequence comprises a plurality of photographs which are obtained and displayed concurrently.
